(19) United States
(12) Patent Application Publication
(10) Pub. No.: US 2013/0139428 A1
(43) Pub. Date: Jun. 6, 2013

(54) COUPLING ELEMENTS OF DISSIMILAR GALVANIC POTENTIAL TO ALTER BEHAVIOR OF ELECTRO-SENSITIVE ORGANISMS

(71) Applicants: Kieran T. SMITH, Boca Raton, FL (US); Stephen M. KAJIURA, Boca Raton, FL (US)

(72) Inventors: Kieran T. SMITH, Boca Raton, FL (US); Stephen M. KAJIURA, Boca Raton, FL (US)

(21) Appl. No.: 13/691,978

(22) Filed: Dec. 3, 2012

Related U.S. Application Data
(60) Provisional application No. 61/566,221, filed on Dec. 2, 2011.
(60) Provisional application No. 61/681,235, filed on Aug. 9, 2012.

(51) Int. Cl. A01K 79/02

(52) U.S. Cl. CPC A01K 79/02
USPC 43/17.1; 119/220

(57) ABSTRACT

Devices and methods are disclosed for using materials with dissimilar galvanic potentials for altering the behavior of electro-sensitive organisms. This includes devices for mitigating elasmobranch bycatch in commercial and recreational fisheries.

### CROSS-REFERENCE TO RELATED APPLICATIONS

This invention claims the benefit of U.S. Provisional Application No. 61/566,221, filed Dec. 2, 2011 and U.S. Provisional Application No. 61/681,235, filed Aug. 9, 2012, the contents of which are both hereby incorporated by reference in their entirety.

### FIELD OF THE INVENTION

This invention relates generally to materials with dissimilar galvanic potentials, such as zinc and graphite, as a repellent or deterrent for altering the behavior of electro-sensitive organisms. In a general application this invention can be used for the purpose of reducing elasmobranch bycatch in commercial and recreational fishing.

### BACKGROUND OF THE INVENTION

Technological advancements in commercial fishing gear have allowed international fleets to substantially increase both their range and catch per unit effort, CPUE (Kennelly and Broadhurst, 2002). However, improved CPUE results in a concomitant increase in unwanted, non-target species, or bycatch. The US National Oceanic and Atmospheric Administration (NOAA) National Marine Fisheries Service defines bycatch as, “discarded catch of any living marine resource plus retained incidental catch and unobserved mortality due to a direct encounter with fishing gear”. In pelagic longline fisheries, impacted animals include sea birds, sea turtles, marine mammals, non-targeted teleost fish and elasmobranchs (Lewison et al., 2004).

Elasmobranchs fishes (sharks, skates, and rays) constitute a large percentage of bycatch throughout much of the world's pelagic longline fisheries. Approximately 25% of the catch on US longline vessels between 1992-2003 consisted of elasmobranchs (Abercrombie et al. 2005). Alarmingly, these catch rates are comparable to that of target species, such as swordfish and tuna, and could potentially lead to massive declines in shark populations. Due to the late maturation and low fecundity of most shark species relative to teleost fishes, they are considered highly susceptible to overfishing and drastic declines in numbers could prove catastrophic to the overall health and vitality of our oceans. As a result, it is of great importance to mitigate bycatch of elasmobranchs in pelagic longline fisheries in ways that do not impact catch rates of target species.

Although the target species and elasmobranch bycatch are trophically similar, only the elasmobranchs possess an electrosensory system. Elasmobranchs utilize their highly developed electrosensory system to facilitate prey capture, predator detection, communication, and possibly for use in navigation (Kalmijn, 1982; Tricas and Sisneros, 2004; Tricas et al., 1995; Coombs et al., 2002). Because teleost species targeted by commercial longline fishing lack electrosensory systems, recent work has investigated whether electric stimuli can be employed to deter sharks from biting baited hooks (Kaimmer and Stoner, 2008; Stoner and Kaimmer, 2008; Wang et al., 2008; Brill et al., 2009; Tallack and Mandelman, 2009; Robbins et al., 2011; Jordan et al., 2011; McCutcheon and Kajiura, 2012). These studies have focused on the naturally electrogenic lanthanide elements (electropositive metals) as potential shark deterrents.

Lanthanide elements have shown promise as potential shark deterrents. They are highly reactive when immersed in seawater and readily undergo dissolution by means of hydrolysis. This process generates voltage which is within a range detectable by the elasmobranch electrosensory system. Studies have shown this voltage is strong enough to alter the behavior of elasmobranchs and reduce catch rates of sharks, skates, and rays on hooks treated with lanthanide elements (Kaimmer and Stoner, 2008; Stoner and Kaimmer, 2008; Wang et al., 2008; Brill et al., 2009).

Certain shortcomings exist when using lanthanide metals for shark deterrents or repellents. Lanthanide metals undergo rapid dissolution and have been shown to lose up to 70% of their mass in just 40 hours of soak time (Stoner and Kaimmer 2008). As a result, the metals must be replaced often.

Increased demand for lanthanide elements for use in electronics has dramatically increased prices. For example, in 2012 the lanthanide metal neodymium ranged in price from US $145.00-$445.00 kg⁻¹. As a result, the economic feasibility of lanthanide elements for use as sacrificial shark deterrents in commercial and recreational fishing is considerably diminished.

Lanthanide metals are also highly reactive when machined producing filings and dust that are extremely flammable.

Based on the rapid dissolution, cost, and high reactivity, the adoption of lanthanide metals for commercial application is quite limited, making the development of less hazardous, cheaper alternatives desirable.

The present invention utilizes an electrochemical galvanic interaction between materials with dissimilar galvanic potentials to create a voltage similar in magnitude to that of lanthanide metals for a fraction the cost.

### SUMMARY OF THE INVENTION

The applicants have discovered that coupling elements with dissimilar galvanic potentials, such as zinc and graphite, creates in salt water a voltage capable of repelling electro-sensitive organisms, including elasmobranch fishes (sharks, skates, and rays) and reducing catch rates of elasmobranchs in longline fishing by up to 80%.

According to the non-limiting embodiment of the present invention, a device capable of repelling electro-sensitive organisms is comprised of two or more materials with different galvanic potentials that, when juxtaposed and immersed in an electrolyte such as seawater, facilitates electron flow from one material to another. This process creates voltage within a range detectable by the elasmobranch electrosensory system which repels or deters the shark, skate, or ray.

The materials with dissimilar galvanic potentials are preferably chosen from opposite ends of the galvanic series in order to facilitate creation of a voltage capable of altering the behavior of electro-sensitive organisms.

According to the first non-limiting aspect of the present invention, a device is comprised of two or more materials with dissimilar galvanic potentials, an example being zinc and graphite, which, when juxtaposed and immersed in seawater, creates a voltage capable of altering the behavior of elasmobranchs.

According to the second non-limiting aspect of the present invention, a device comprised of two or more materials with dissimilar galvanic potentials, an example being zinc and graphite, is used in association with fishing gear, nets, hooks, or tackle or any combination thereof, to reduce catch rates of elasmobranchs in commercial or recreational fishing.

The present invention has several advantages over using lanthanide metals for elasmobranch bycatch mitigation.

The cost of lanthanide elements is quite high with the price of neodymium in 2012 ranging from US $145.00-$445.00 kg⁻¹. Comparatively, the price of the zinc/graphite galvanic deterrent is relatively cheap with zinc priced at ˜US $2.00 kg⁻¹ and graphite priced at ˜US $6.00 kg⁻¹.

Lanthanide metals are also extremely reactive and flammable. In contrast, zinc and graphite are easily machined and neither poses a risk to health or safety.

Lanthanide metals also undergo rapid dissolution and must be replaced regularly to maintain a deterrent or repulsive effect on electro-sensitive organisms. In contrast, the zinc portion of the galvanic deterrent used in this invention builds up a thin layer of oxidation that can be sanded off to re-expose bare metal allowing it to be reused many times over. The graphite portion of the deterrent remains unchanged and is entirely reusable.

### BRIEF DESCRIPTION OF THE DRAWINGS

In order to describe the present invention by way of example, the accompanying drawings and figures are discussed.

FIG. 1 illustrates a typical J-style hook which has been treated with a galvanic deterrent, in this case juxtaposed zinc and graphite.

FIG. 2 illustrates a typical circle hook which has been treated with a galvanic deterrent, in this case juxtaposed zinc and graphite.

FIGS. 3A-3C illustrates views of a typical J-style hook which has been treated with a galvanic deterrent, in this case juxtaposed zinc and graphite. FIG. 3A represents a side view of the hook and the galvanic deterrent.

FIG. 4 illustrates the general configuration of gear for a pelagic longline fishing vessel.

FIG. 5 illustrates a fishing net which has been treated with a galvanic deterrent, in this case juxtaposed zinc and graphite.

FIG. 6 illustrates the voltage produced by equal size Zinc/Graphite and Neodymium samples in seawater at various distances from a recording electrode.

FIG. 7 illustrates catch per unit effort (CPUE) and total number of elasmobranch catch on 17 neodymium treatment sets and 17 zinc/graphite treatment sets.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

“Bycatch” is defined as discarded catch of any living marine resource plus retained incidental catch and unobserved mortality due to a direct encounter with fishing gear. In a longline fishery targeting swordfish, any non-target species such as seabirds, marine mammals, other teleost fishes, or elasmobranch fishes are considered bycatch.

“Elasmobranchs” in this specification refers to any species belonging in the subclass elasmobranchii. This includes all species of sharks, skates and rays.

“CPUE” or catch per unit effort is a standardization used to compare catch rates on vessels using different gear. In the study outlined in the present invention, we have standardized CPUE as the number of sharks caught per hook hour of soak time.

“Longline Fishing” refers to a technique in which a long mainline extending up to many miles is deployed with tens, hundreds, or thousands of baited hooks attached via gangions. The gangions consist of a tuna clip and a monofilament or wire leader terminating with a hook.

Galvanic interaction between elements with dissimilar galvanic potentials creates in seawater electron flow from the anodic material to the cathodic material resulting in voltage production. This voltage alters the behavior of electro-sensitive organisms, specifically elasmobranch fishes, deterring or repelling them from biting baited hooks.

In order for galvanic interaction to occur, three conditions must be met: 1) the metals must be far apart on the galvanic series, 2) the metals must be in electrical contact with one another, and 3) the metal junction must be bridged by an electrolyte (Atlas, 2010).

The inventors have discovered a novel technique to alter the behavior of electro-sensitive organisms. This invention utilizes the electric field created as a result of the galvanic interactions between materials with dissimilar galvanic potentials, in this case zinc and graphite. When immersed in the unlimited electrolyte salt water, the anode (zinc) and the cathode (graphite) essentially create a battery. The resultant electron flow between cathode and anode, created by galvanic interaction, produces an electric field well within the range detectable by the electrosensory system of elasmobranch fishes.

Elasmobranchs use their electrosensory system to detect the minute bioelectric field produced by prey. It has been shown that elasmobranchs can detect voltage gradients as low as 1 nV/cm (Kajiura and Holland 2002). When exposed to an electric stimulus many orders of magnitude greater than what is naturally encountered within the environment, the shark's electrosensory system will likely be overwhelmed, eliciting a repulsive response. This hypothesis has been tested through the use of lanthanide elements as possible shark deterrents (Stoner and Kaimmer 2008; Wang et al 2008; Brill et al 2009) but never through the use of dissimilar metals, specifically zinc and graphite.

The electric field produced by similarly sized neodymium metals and zinc/graphite configurations were compared and found to be nearly identical. As a result, the inventors were able to elicit a similar repulsive response by elasmobranchs for a fraction of the cost. The cost of lanthanide elements is quite high with the price of neodymium in 2012 ranging from US $145.00-$445.00 kg⁻¹. Comparatively, the price of the zinc/graphite galvanic deterrent is relatively cheap with zinc costing ˜US $2.00 kg⁻¹ and graphite costing ˜US $6.00 kg⁻¹.

The galvanic deterrent, in this case juxtaposed zinc and graphite bricks, produced an even greater deterrent effect for a small percentage of the cost of the lanthanide metal neodymium.

As the zinc (anode) and graphite (cathode) interact within salt water, a fine layer of oxidation accumulates on the zinc. Over time this process will likely lessen the electric field created. However, this thin layer of oxidation can be sanded and removed after each deployment allowing the zinc to be reused many times over.

Lanthanide metals are quite reactive and extremely difficult to manufacture and machine. In fact, the metal filings which result from the machining process are highly flammable and present a fire hazard. Comparatively, zinc and graphite are far more stable substances that are easily machined and manufactured.

A apparatus, such as, a hook, for altering a behavior of an electrosensitive organism in saltwater, according to the various embodiments, can include a first element having a first surface, a second element having a second surface, and a fastener for attaching the first element to the second element such that the first surface contacts the second surface. In this apparatus, the first element comprises a first composition with a first galvanic corrosion potential in salt water, wherein the second element comprises a second composition with a second galvanic corrosion potential in the salt water that is different from the first galvanic corrosion potential, and wherein the difference between the first galvanic corrosion potential and the second galvanic corrosion potential results in a voltage gradient in the salt water that overwhelms an electrosensory system of the electrosensitive organism in the salt water.

The first composition can be a composition having a galvanic corrosion potential greater than 0 in saltwater and the second composition can be a composition having a galvanic corrosion potential less than 0V in saltwater. For example, the second composition comprises a composition having a galvanic corrosion potential less than −0.4V, −0.7, or −1.0 in saltwater.

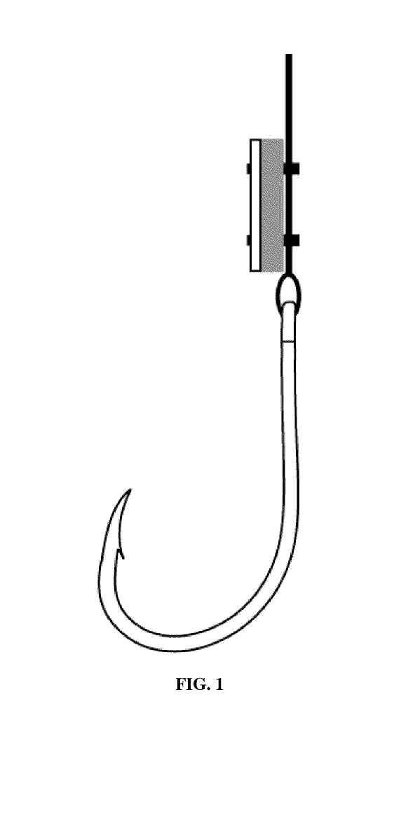

FIG. 1 illustrates a typical J-style hook which has been treated with a galvanic deterrent, in this case juxtaposed zinc and graphite. Whereas the treatment has been added just above the hook, other placement and techniques could be used to treat the hook or gangion. However, because the voltage produced by the galvanic deterrent decays quickly with distance, it should be placed as close as possible to the hook itself or possibly used in a coating or construction of the hook. In addition, whereas the treatment is depicted as rectangular blocks of zinc and graphite, other shapes and configurations could be used.

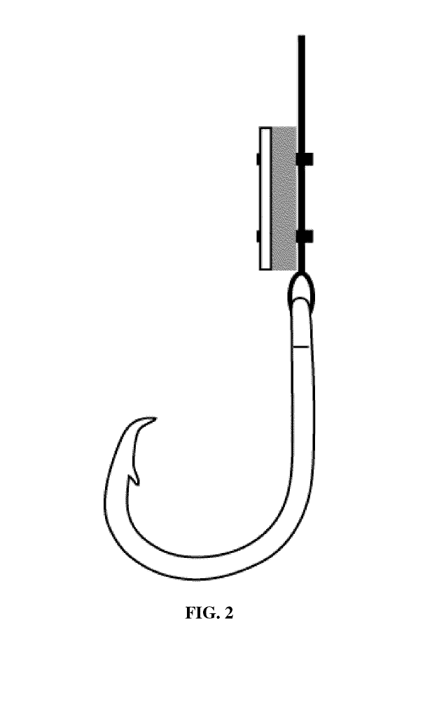

FIG. 2 illustrates a typical circle hook which has been treated with a galvanic deterrent, in this case juxtaposed zinc and graphite. Whereas the treatment has been added just above the hook, other placement and techniques could be used to treat the hook or gangion. However, because the voltage produced by the galvanic deterrent decays quickly with distance, it should be placed as close as possible to the hook itself or possibly used in a coating or construction of the hook. In addition, whereas the treatment is depicted as rectangular blocks of zinc and graphite, other shapes and configurations could be used.

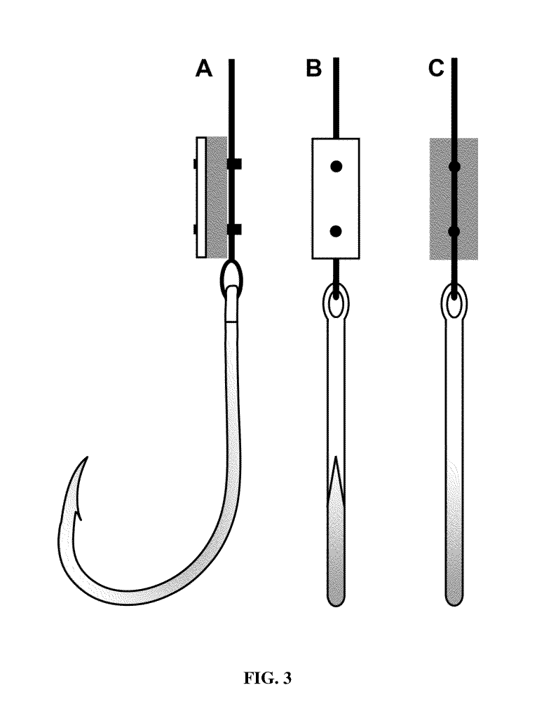

FIG. 3 illustrates views of a typical J-style hook which has been treated with a galvanic deterrent, in this case juxtaposed zinc and graphite. FIG. 3A represents a side view of the hook and the galvanic deterrent. FIG. 3B represents a view of the hook and galvanic deterrent from the hooks point. FIG. 3C represents the hook and galvanic deterrent from the back or shank of the hook. Whereas the treatment has been added just above the hook, other placement and techniques could be used to treat the hook or gangion. However, because the voltage produced by the galvanic deterrent decays quickly with distance, it should be placed as close as possible to the hook itself or possibly used in a coating or construction of the hook. In addition, whereas the treatment is depicted as rectangular blocks of zinc and graphite, other shapes and configurations could be used.

The various embodiments can be used to form a fishing apparatus, including, for example, a line, a fishing hook mechanically coupled to a first end of the line, and a repellant device mechanically coupled to a first end of the line adjacent to the fishing hook. The repellant device can be similar to the apparatus described above.

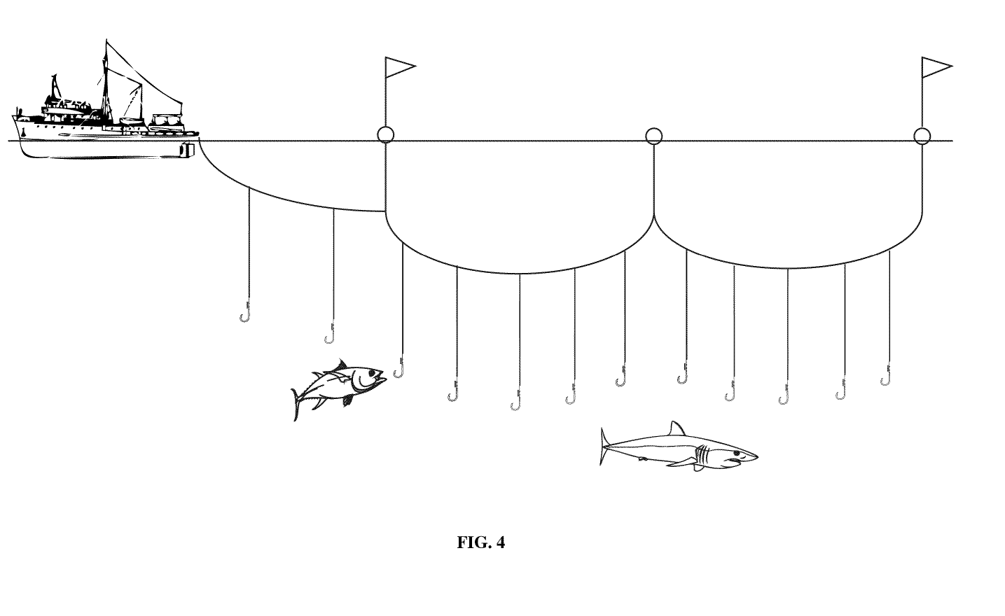

FIG. 4 illustrates the general configuration of gear for a pelagic longline fishing vessel using such an apparatus. The mainline is deployed from a vessel with buoys placed at determined distances along the length of the line. Between the buoys, gangions are attached that consist of a tuna clip, and monofilament or wire leader terminating at a hook. The hook is treated with two or more materials with dissimilar galvanic potentials. In this case, zinc and graphite are used to deter or repel non-target elasmobranch species from being caught leaving the hooks to catch target species such as swordfish and tuna. However, the galvanic deterrent could be used in any type of commercial or recreational fishing practices to repel electro-sensitive organisms.

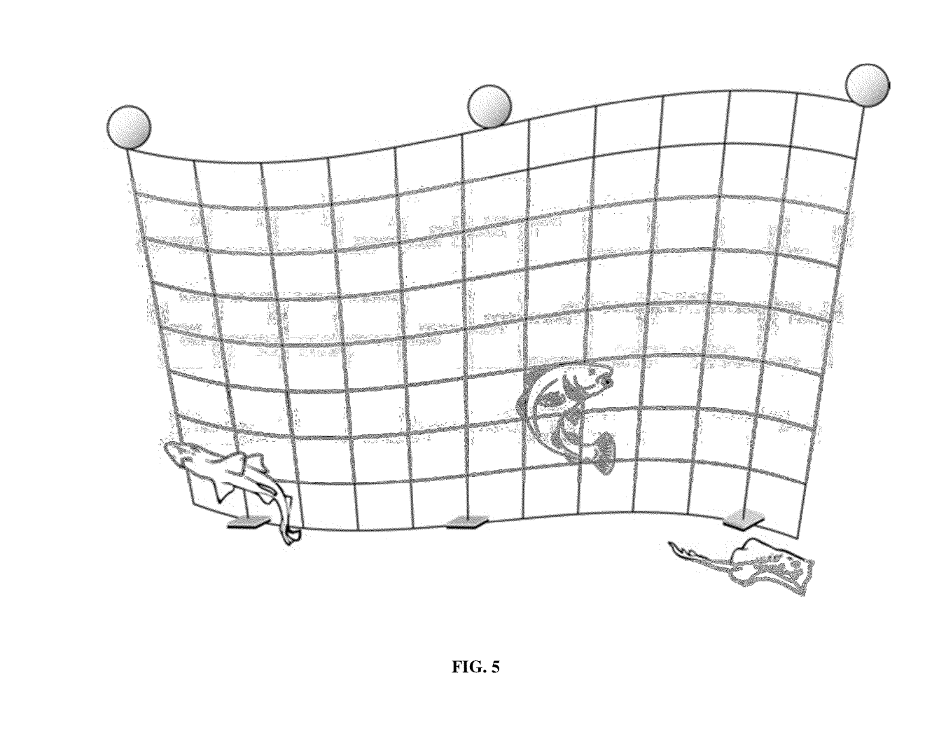

FIG. 5 illustrates the general configuration of a deployed fishing net. The net is treated with two or more materials with dissimilar galvanic potentials. In this case, zinc and graphite are used to deter or repel non-target elasmobranch species from being caught leaving the net to catch target species.

The various embodiments also provide for methods of altering a behavior of an electrosensitve organism in salt water. An exemplary method can include providing a repellant device as described above and disposing the repellant device in a selected area of a body of saltwater in which a behavior of the electrosensitive organism is to be altered. For example, the disposing further can include providing a fishing hook attached to a first end of the line, attaching the repellant device to the first end of the line adjacent to the fishing hook, and placing the fishing hook, the first end of the line, and the repellant device in the selected area.

### EXAMPLES

The following non-limiting Examples serve to illustrate selected embodiments of the invention. It will be appreciated that variations in proportions and alternatives in elements of the components shown will be apparent to those skilled in the art and are within the scope of embodiments of the invention.

I. Voltage Measurements of the Lanthanide Metal Neodymium Compared to the Galvanic Deterrent Zinc/Graphite

Voltage production by equal sized samples of zinc/graphite and neodymium were measured in seawater. Treatments consisted of neodymium (99.5%, CSTRAM Advanced Materials Co. Shanghai, China), zinc (99.7%, McMaster Carr. Santa Fe Springs, Calif. USA), and GM-10 isomolded graphite (Graphtek LLC, Buffalo Grove, Ill. USA) cut into bricks measuring 5.08×5.08×0.635 cm. The voltage was measured from 2 juxtaposed neodymium (Nd) bricks, and for a brick of zinc (Zn) juxtaposed with a brick of graphite (Gr). To measure voltage, a sample was affixed to an acrylic arm on a vertical linear actuator which was mounted to a horizontal 300 mm eTrack linear translation stage (Newmark Systems Incorporated, Rancho Santa Margarita, Calif.) adjacent to an acrylic experimental tank (89×43×21 cm) equipped with flow-through seawater. This enabled precise placement of samples in the seawater at desired distances from a recording electrode mounted in the center of the tank. The recording electrode was a non-polarizable Ag—AgCl pellet electrode (E45P-M15NH, Warner Instruments, Hamden, Conn., USA) in 3.0 M KCl and fitted with a seawater/agar-filled glass capillary tube that terminated in a 100 μm diameter tip at mid-depth in the tank. A reference electrode was positioned in the far corner of the experimental tank. The output from the two electrodes was differentially amplified (DP-304, Warner Instruments, Hamden, Conn.) at 1000-10,000×, filtered (0.1 Hz-0.1 kHz, 60 Hz notch; DP-304, Warner Instruments & Hum Bug, Quest Scientific, North Vancouver, British Columbia), digitized at 1 kHz using a Power Lab® 16/30 model ML 880 (AD Instruments, Colorado Springs, Colo., USA) and recorded using Chart™ Software (v.5, AD Instruments). To measure the voltage, a sample was zip tied to the non-conductive acrylic arm of the linear actuator. The sample was then translated to a position 1, 2, 3, 4, 5, 10, 15, 20, 25, or 30 cm from the recording electrode. The actuator then dipped the sample into the water and a voltage measurement was obtained. The actuator then removed the sample from the water, the sample was translated to one of the other randomly chosen distances, dipped again, and the process repeated until measurements were obtained at all distances from the recording electrode. Each sample was replaced after every cycle of measurements and 6 replicates were conducted for each treatment type. The replicate measurements were averaged and plotted against distance to determine the voltage decay with distance for the neodymium and zinc/graphite treatments.

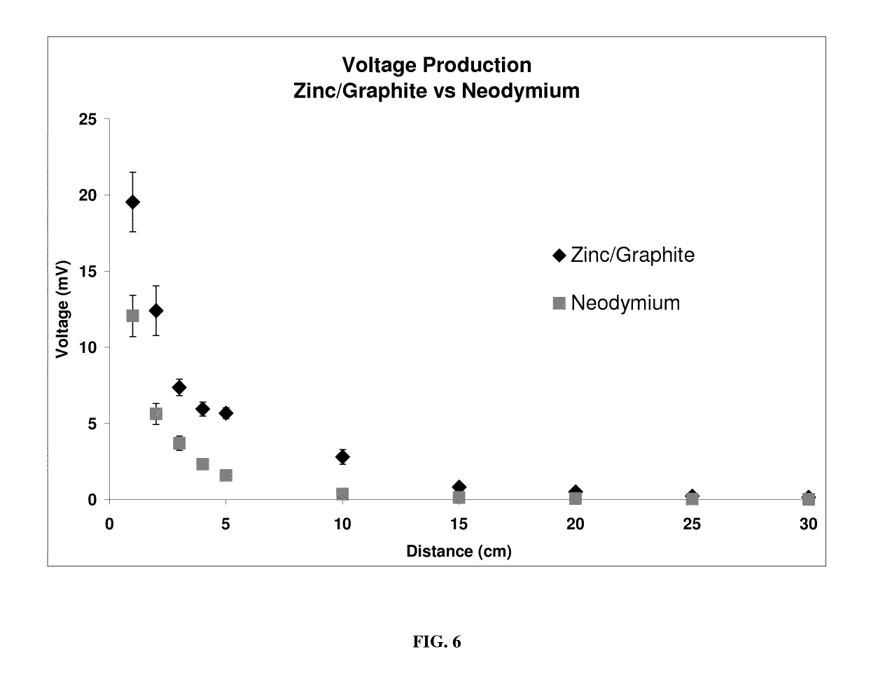

FIG. 6 shows the results of voltage measurements conducted using the methods described above. Voltage produced by equally sized neodymium and zinc/graphite samples in seawater were not significantly different (ANOVA, F=2.39, p=0.1397). The next step tested both neodymium and zinc/graphite in a controlled scientific longline fishing study.

II. Results of a Controlled Scientific Longline Fishing Study Comparing the Lanthanide Metal Neodymium and a Zinc and Graphite Galvanic Deterrent

Scientific longline fishing was conducted in Apalachee Bay near St. Theresa, Fla. Each 60 hook set utilized modified demersal longline gangions which consisted of a tuna clip attached to a 2 m length of 1.80 mm monofilament line that terminated in a 1 m length of 1.8 mm stainless steel leader. To the stainless steel leader was attached either a 14/0 or 16/0 Mustad circle hook. A float was fastened via zip tie on each gangion where the monofilament attached to the stainless steel leader. The float maintained the hook within the water column allowing the bait to remain off the substrate. 34 longline sets were conducted with 17 sets utilizing neodymium treatments and 17 sets utilizing zinc juxtaposed with graphite. A systematic block design was implemented in both neodymium treatment and zinc/graphite treatment longline sets. The neodymium (treatment), epoxy encased lead (procedural control), and untreated hook (control) were alternated among 16/0 and 14/0 hooks. Zinc/graphite (Zn/Gr) treatment sets utilized the same systematic block design alternating Zn/Gr (treatment), grey/black acrylic (procedural control), and untreated hook (control) among 16/0 and 14/0 hooks. Treatments and controls were affixed with zip ties to the stainless steel leader directly above the hook. The hooks were baited with cut chunks of mackerel (Scomber sp.) and each gangion was attached to the mainline every 10-15 m. A lead sash weight was clipped to the mainline after every 8 gangions to keep the mainline along the substrate and distribute the hooks evenly within the water column. Procedures for the Zn/Gr treatment sets were identical to neodymium sets with two exceptions; a zinc brick juxtaposed with a graphite brick (treatment), each sample measuring 6.4×1.3×0.635 cm, was supplemented for the neodymium, and a gray/black acrylic (procedural control) equal in size to the zinc/graphite was supplemented for epoxy encased lead (procedural control). The target soak time for each set was 1-1.5 hours. After every three sets, neodymium treatments were replaced with new samples due to rapid dissolution and the zinc was separated from the graphite and sanded using an angle grinder to remove oxidation then juxtaposed with the graphite again via zip tie for use the following day. As the sets were retrieved, the species, size, and hook treatment were recorded for all specimens. Data were converted to catch per unit effort CPUE (# sharks/hook hour) and shark catch was analyzed by means of Chi Squared tests with the significance level set at p<0.05 to determine if fewer sharks were caught on treated hooks.

Between 21 May 2011 and 13 Jun. 2012, a total of 34 demersal longlines were set in Apalachee Bay, Fla. (average depth=3.95 m) resulting in 330 sharks caught. On neodymium treatment sets 173 sharks were caught with 79 on untreated hooks, 67 on epoxy encased lead controls, and 27 on neodymium treated hooks. Catch rate on untreated hooks and procedural controls did not differ significantly (λ²=0.97, p=0.321, N=146) but both yielded significantly greater catch rates than the neodymium treated hooks. There was a 65% reduction in sharks caught on neodymium treated hooks compared to untreated hooks (λ²=25.51, p<0.001, N=106) and a 60% reduction in sharks caught on neodymium treated hooks compared to epoxy encased lead procedural controls (λ²=17.02, p<0.001, N=94).

On zinc/graphite treatment sets 153 sharks were caught with 84 on untreated hooks, 61 on acrylic controls, and 12 on Zn/Gr treated hooks (FIG. 6). Catch rate on untreated hooks and acrylic controls did not differ significantly (λ²=3.65, p=0.056, N=145) but both yielded significantly greater catch rates than the Zn/Gr treated hooks. There was an 85% reduction in shark catch rates on Zn/Gr treated hooks compared to untreated hooks (λ²=54.00, p<0.001, N=96) and an 80% reduction on Zn/Gr treated hooks compared to acrylic procedural controls (λ²=32.89, p<0.001, N=73).

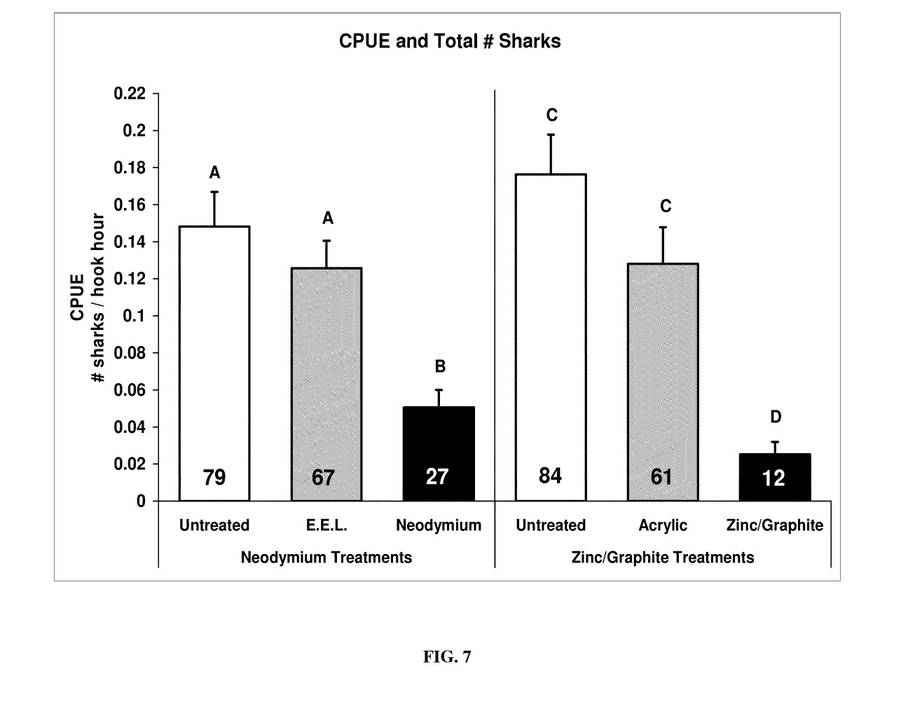

FIG. 7 shows catch per unit effort (CPUE) and total number of elasmobranchs caught on 17 neodymium treatment sets and 17 zinc/graphite treatment sets. Neodymium treatment sets show no significant difference when comparing untreated hooks and epoxy encased lead procedural controls. A significant 60% reduction was found when comparing shark catch rates on neodymium treated hooks to epoxy encased lead procedural controls. Zinc/graphite treatment sets show no significant difference when comparing untreated hooks and acrylic procedural controls. A significant 80% reduction in shark CPUE was found when comparing catch on zinc/graphite treated hooks and acrylic procedural controls.

The results of this controlled scientific longline fishing study show a greater decrease in shark catch rates can be achieved using the zinc/graphite deterrent when compared to the lanthanide metal neodymium. During the course of this fishing study, approximately US$1600.00 worth of neodymium was used. This was required due to the rapid dissolution of the lanthanide metal in salt water which has been shown to lose up to 70% of its mass in just 40 hours of soak time (Stoner and Kaimmer, 2008). However, only US $62.50 worth of zinc and graphite were used. This is because we were able to sand the layer of oxidation off the zinc after every day of fishing and reuse both the zinc and graphite for the entire study. Based on rate of oxidation of the zinc, we estimate that we could use the same samples for approximately 40 more sets. Based on these results, we believe we have discovered a novel and far more cost effective method to create the same deterrent effect that has the potential for large scale use in commercial long line fishing.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### LITERATURE CITED

Abercrombie, D. L., Balchowsky, H. A., Paine, A. L., 2005. 2002 and 2003 annual summary: large pelagic species. NOAA Technical Memorandum, NMFS SEFSC-529, 33pp
Brill, R., Bushnell, P., Smith, L., Speaks, C., Sundaram, R., Stroud, E., Wang, J. 2009. The repulsive and feeding-deterrent effects of electropositive metals on juvenile sandbar sharks (Carcharhinus plumbeus). Fisheries Bulletin 107: 298-307.
Coombs, S., New, J. G., and Nelson M. 2002. Information-processing demands in electrosensory and mechanosensory lateral line systems. J. Physiol. Paris 96: 341-354
Jordan, L. K., Kajiura, S. M., Mandelman, J. W., 2011. Behavioral responses to weak electric fields and a lanthanide metal in two shark species. Journal of Experimental Marine Biology and Ecology 409: 345-350
Kaimmer, S., Stoner, A. W., 2008. Field investigation of rare-earth metal as a deterrent to spiny dogfish in the Pacific haligut fishery. Fish. Res. 94: 43-47
Kajiura, S. M., Holland, K. N. 2002. Electroreception in juvenile scalloped hammerhead and sandbar sharks. Journal of Experimental Biology 205: 3609-3621
Kalmijn, A. J. 1982. Electrical and magnetic field detection in elasmobranch fishes. Science 118: 916-918.
Kennelly, S. J. & Broadhurst M. K. 2002. By-catch begone: changes in the philosophy of fishing technology. Fish and Fisheries 3, 340-355.
Lewison, R. L., Crowder, L. B., Read, A. J., Freeman, S. A. 2004. Understanding impacts of fisheries bycatch on marine megafauna. Trends in Ecology and Evolution 19: 598-604
McCutcheon, S., Kajiura, S. M., 2012. Electropositive metals as potential shark deterrents. Masters Thesis. Florida Atlantic University.
Robbins, W. D., Peddemors, V. M., Kennelly, S. J., 2011. Assessment of permanent magnets and electropositive metals to reduce the line-based capture of Galapagos sharks, Carcharhinus galapagensis. Fish Res. 109: 100-106
Stoner, A. W., Kaimmer, S. M 2008. Reducing elasmobranch bycatch: Laboratory investigations of rare earth metal and magnetic deterrents with spiny and Pacific halibut. Fisheries Research 92: 162-168.
Tallack, S. M., Mandelman, J. W., 2009. Do rare-earth metals deter spiny dogfish? A feasibility study on the use of lanthanide “mischmetal” to reduce the bycatch of Squalus acanthias by hook gear in the Gulf of Maine. ICES J. Mar. Sci. 66, 315-322
Tricas, T. C., S. W. Michael and J. A. Sisneros. 1995. Electrosensory optimization to conspecific phasic signals for mating. Neuroscience Letters 202(1-2):129-132
Tricas, T. C. and J. A. Sisneros. 2004. Ecological functions and adaptations of the elasmobranch electrosense, pp. 308-329. In: G. von der Emde, J. Mogdans & B. G. Kapoor (eds.), The Senses of Fish: Adaptations for the Reception of Natural Stimuli, Narosa Publishing House, New Delhi Wang, J., McNaughton, L., Swimmer, Y. 2008. Galapagos and sandbar shark aversion to electropositive metal (Pr—Nd alloy). In: Swimmer, Y., Wang, J. H., McNaughton, L. M. (eds), Shark Deterrent and Incidental Capture Workshop.

What is claimed is:

1. A apparatus for altering a behavior of an electrosensitive organism in saltwater, comprising:
a first element having a first surface;
a second element having a second surface; and
a fastener for attaching the first element to the second element such that the first surface contacts the second surface,
wherein the first element comprises a first composition with a first galvanic corrosion potential in salt water, wherein the second element comprises a second composition with a second galvanic corrosion potential in the salt water that is different from the first galvanic corrosion potential, and wherein the difference between the first galvanic corrosion potential and the second galvanic corrosion potential results in a voltage gradient in the salt water that overwhelms an electrosensory system of the electrosensitive organism in the salt water.

2. The apparatus of claim 1, wherein the electrosensitve organism is a shark.

3. The apparatus of claim 1, wherein the first composition is graphite and the second composition is zinc.

4. The apparatus of claim 1, wherein the first composition comprises a composition having a galvanic corrosion potential greater than 0 in saltwater.

5. The apparatus of claim 4, wherein the second composition comprises a composition having a galvanic corrosion potential less than 0V in saltwater.

6. The apparatus of claim 4, wherein the second composition comprises a composition having a galvanic corrosion potential less than −0.4V in saltwater.

7. The apparatus of claim 4, wherein the second composition comprises a composition having a galvanic corrosion potential less than −0.7V in saltwater.

8. The apparatus of claim 4, wherein the second composition comprises a composition having a galvanic corrosion potential greater than −1V in saltwater.

9. A fishing apparatus, comprising
a line;
a fishing hook mechanically coupled to a first end of the line;
a repellant device mechanically coupled to a first end of the line adjacent to the fishing hook,
wherein the repellant device comprises a first element having a first surface, a second element having a second surface, and a fastener for attaching the first element to the second element such that the first surface contacts the second surface,
wherein the first element comprises a first composition with a first galvanic corrosion potential in salt water, wherein the second element comprises a second composition with a second galvanic corrosion potential in the salt water that is different from the first galvanic corrosion potential, and wherein the difference between the first galvanic corrosion potential and the second galvanic corrosion potential results in a voltage gradient in the salt water that overwhelms an electrosensory system of an electrosensitive organism in the salt water.

10. A method of altering a behavior of an electrosensitve organism in salt water, comprising:
providing a repellant device comprising a first element having a first surface, a second element having a second surface, and a fastener for attaching the first element to the second element such that the first surface contacts the second surface, wherein the first element is selected to comprise a first composition with a first galvanic corrosion potential in salt water, wherein the second element is selected to comprise a second composition with a second galvanic corrosion potential in the salt water that is different from the first galvanic corrosion potential, and wherein the first and the second compositions are selected to provide a difference between the first galvanic corrosion potential and the second galvanic corrosion potential that results in a voltage gradient in the salt water that overwhelms an electrosensory system of the electrosensitive organism in the salt water; and
disposing the repellant device in a selected area of a body of saltwater in which a behavior of the electrosensitive organism is to be altered.

11. The method of claim 10, wherein the electrosensitve organism is a shark.

12. The method of claim 10, wherein providing the repellant device comprises selecting the first composition to be graphite and selecting the second composition to be zinc.

13. The method of claim 10, wherein providing the repellant device comprises selecting the first composition to comprise a composition having a galvanic corrosion potential greater than 0 in saltwater.

14. The method of claim 13, wherein providing the repellant device comprises selecting the second composition to comprise a composition having a galvanic corrosion potential less than 0V in saltwater.

15. The method of claim 13, wherein providing the repellant device comprises selecting the second composition to comprise a composition having a galvanic corrosion potential less than −0.4V in saltwater.

16. The method of claim 13, wherein providing the repellant device comprises selecting the second composition to comprise a composition having a galvanic corrosion potential less than −0.7V in saltwater.

17. The method of claim 13, wherein providing the repellant device comprises selecting the first composition to comprise a composition having a galvanic corrosion potential greater than −1V in saltwater.

18. The method of claim 10, wherein the disposing further comprises:
providing a fishing hook attached to a first end of the line;
attaching the repellant device to the first end of the line adjacent to the fishing hook;
placing the fishing hook, the first end of the line, and the repellant device in the selected area.
